(19) United States
(12) Patent Application Publication
(10) Pub. No.: US 2007/0280136 A1
(43) Pub. Date: Dec. 6, 2007

(54) SIP-based instant messaging in mobile ad hoc networks

(75) Inventors: Qing Chen, Beijing (CN); Zhiseng Niu, Beijing (CN); Ling Qian, Beijing (CN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/585,084

(22) Filed: Oct. 24, 2006

(30) Foreign Application Priority Data
May 31, 2006 (CN) 200610087727.3

(51) Int. Cl. H04L 12/56; H04L 12/28

(52) U.S. Cl. 370/254; 370/400

(57) ABSTRACT

In an embodiment of a method for registering a first device in a mobile ad-hoc network (MANET), a registration message is sent to 1-hop neighboring devices. The registration message includes a hop-limit and a freshness indicator of the first device. The freshness indicator indicates an experience level of the first device in the MANET, and the hop-limit indicates a limit on the number of hops for forwarding the registration message. According to another embodiment, a registration message of the first device is received. The registration message includes a first freshness indicator, and the first freshness indicator indicates the freshness of the registration message. Based on the received registration message, a reverse registration message may be sent and/or the registration message may be forwarded to other devices.

### PRIORITY STATEMENT

This non-provisional U.S. patent application claims priority under 35 U.S.C. § 119 to Chinese Patent Application No. 200610087727.3, filed on May 31, 2006, the entire contents of which are incorporated herein by reference.

### BACKGROUND OF THE INVENTION

Mobile Ad hoc Networks (MANET) are designed to provide network devices with a means to communicate in areas where no base stations, routers, or access points are available, for example, battlefields, post-disaster regions, and other areas lacking network capabilities. MANETs may be used for any purpose commonly associated with networks, such as making voice and video calls, sharing photos, audio, and video clips, playing games, and generally exchanging information. There has been some research into using aspects of the Session Initiation Protocol (SIP) as a resource and location management mechanism.

SIP is a signaling protocol adopted in 3G networks for setting up, managing, and tearing down sessions. Generally, SIP employs a client/server architecture, wherein each SIP client registers an IP address and a unique ID with a SIP registrar, in a process known as binding. To initiate a communication session, a first client sends a communication request to a SIP redirector or a SIP proxy server. The communication request includes a unique ID of the second client. The SIP redirector or SIP proxy server uses the SIP registrar to correlate the unique ID of the second client with an IP address of the second client, and then forwards the request to the second client. Upon receipt of the communication request by the second client, the first client and second client setup a communication session. Once the communication session is setup, the two clients transfer data using a direct peer-to-peer session.

A problem inherent in the decentralized control and dynamic topology of MANETs involves the difficulty and complexity of locating network services and resources. Existing client/server applications and protocols that use a fixed server or a fixed proxy solution, like Jabber and SIP, are not necessarily suitable for a MANET because the fixed server or fixed proxy is not reliably available. Similarly, while user groups or clusters are reliable for network management in fixed networks, such user groups or clusters may not be suitable for MANET because the unreliable availability of the group or cluster members causes intermittent outages in portions of the network.

While MANETs must employ some form of routing protocol, it may not be beneficial not to depend on a specific routing protocol. A communications solution implementation should avoid requiring that all devices in a MANET activate a special routing application. However, placing a resource location protocol layer between an existing routing protocol layer and an application protocol layer will increase the overhead of the whole network. Furthermore, since many devices already incorporate a number of routing protocols, the MANET application should employ the available routing protocols.

In a standard SIP based MANE, when a new node enters the MANET, the new node sends a SIP registration message to all the other nodes in the MANET. In response, all the other nodes send SIP registration messages to the new node. This procedure requires numerous message exchanges and results in multiple channel collisions.

Therefore, while the standard SIP functions satisfactorily in 1-hop environments, standard SIP tends to fail in multi-hop environments because the broadcast of SIP registration messages exponentially increases the opportunity of collisions in the channels of the MANET.

Therefore, there exists a need for a resource and location management mechanism capable of working efficiently in a MANET environment.

### SUMMARY OF THE INVENTION

In an embodiment of a method for registering a first device in a mobile ad-hoc network (MANET) according to the present invention, a registration message is sent to 1-hop neighboring devices. The registration message includes a hop-limit and a freshness indicator of the first device. The freshness indicator indicates an experience level of the first device in the MANET, and the hop-limit indicates a limit on the number of hops for forwarding the registration message.

In one embodiment, the method may further include incrementing the hop-limit if a reverse registration message is not received within a time-limit after sending the registration message and if the hop-limit is less than a maximum hop-limit. Also, a new registration message is then sent to the 1-hop neighboring devices. The new registration message includes the incremented hop-limit and the freshness indicator.

In one embodiment, the registration message further includes at least one of binding information and presence status. The binding information indicates an association between a unique identifier of the first device and an IP address of the first device, and the presence status indicates the presence of the first device.

In another embodiment, the method may also further include receiving at least one reverse registration message from a second device, and selectively updating a local database at the first device in response to information in the reverse registration message. The reverse registration message may include at least one of a freshness indicator for the second device, a presence status of the second device, and binding information from the second device. The selectively updating step updates the local database at the first device in response to information in the reverse registration message if the freshness indicator for the second device is greater than the freshness indictor for the first device. For example, the updating step may set the freshness indicator for the first device equal to the freshness indicator for the second device.

According to another embodiment of a method for registering a first device in a mobile ad-hoc network (MANET) at a second device, a registration message of the first device is received. The registration message includes a first freshness indicator, and the first freshness indicator indicates the freshness of the registration message. A reverse registration message is selectively sent to the first device if the first freshness indicator is less than a second freshness indicator. The second freshness indicator indicates an experience level of the second device in the MANET. The registration message may further include at least one of binding information of the first device and a presence status of the first device. The binding information associates a unique identifier of the first device with an IP address of the first device and the presence status indicates the presence of the first device. Similarly, the reverse registration message may include at least one of a presence status information for the second device and binding information from the second device.

In one embodiment, the registration message includes a hop-limit, and the selectively sending step sends the reverse registration message to the first device if the first freshness indicator is less than a second freshness indicator and the number of hops between the second device and the first device is less than or equal to the hop-limit.

In yet another embodiment, the method may further include forwarding the registration message to 1-hop neighbors of the second device that did not send the registration message to the second device if the number of hops between the second device and the first device is less than or equal to the hop-limit. The forwarded registration message may be altered to include the hop-limit minus a decrement amount.

Also, in yet another embodiment, the selectively sending step sends the reverse registration message to the first device if the first freshness indicator is less than a second freshness indicator and the hop-limit is greater than zero.

### BRIEF DESCRIPTION OF THE DRAWINGS

The present invention will become more fully understood from the detailed description given below and the accompanying drawings, wherein like elements are represented by like reference numerals, which are given by way of illustration only and thus are not limiting of the present invention.

FIG. 1 illustrates system software modules of a node within a MANET, in accordance with an example embodiment of the present invention;

FIG. 2 illustrates a Broadcasting and hop-limited Batch Reverse Registration (BBRR) process, in accordance with an example embodiment of the present invention.

FIG. 3 illustrates a flow chart of a method for requesting registration of a new node into a MANET, in accordance with an example embodiment of the present invention.

FIG. 4 illustrates a flow chart of an example embodiment of a method for responding to a registration message, in accordance with the present invention.

### DETAILED DESCRIPTION OF THE EMBODIMENTS

Example embodiments of the present invention provide a resource and location management solution that is independent of underlying MANET routing protocols. The example embodiments use an enhanced SIP that may function in a dynamic, multi-hop MANET. The example embodiments provide a fully distributed fault-tolerant communication system and method that use fewer messages, produce fewer channel collisions, and facilitates quick update to account for the dynamic nature the MANET.

In an example embodiment, a MANET may include a plurality of network devices (e.g., wireless phone, wireless equipped PDA, wireless equipped computer, etc.), each represented as a node within the network. Each node may be assigned a unique ID in the MANET, which may be obtained from a MAC address, a social security number of a subscriber associated with the node, a CPU id, or any other identifier that is unique to that node. Alternatively, a form of certification may be used to ensure that every node in the network is assigned a unique ID. Once generated, the ID may be saved in either a volatile or non-volatile memory of the node for future use. When a node connects to the MANET, the unique ID of the node may be bound to an IP address. If a first node seeks to communicate with a second node, the first node may need to find an IP address bound to the second node using the unique ID of the second node.

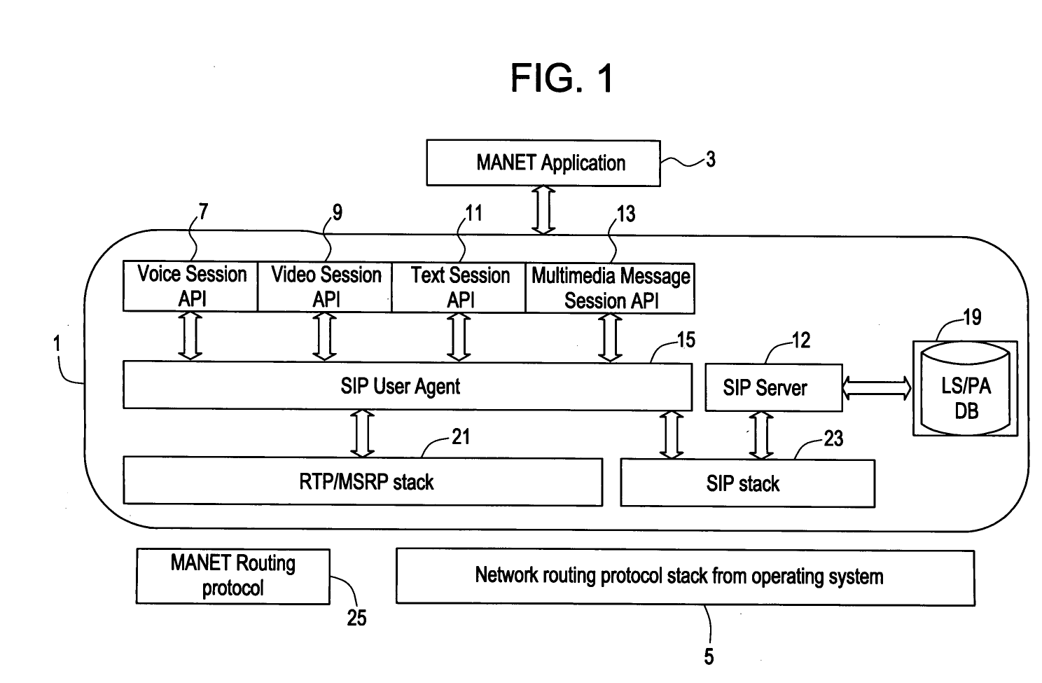

FIG. 1 illustrates system software modules of a node within a MANET, in accordance with an example embodiment of the present invention.

Each node may include a plurality of MANET system modules, such as an enhanced SIP layer (ESIP) 1. The ESIP layer may be a networking layer situated between a MANET application 3 and a networking routing protocol stack 5 used by the operating system. The ESIP layer 1 may include the functional modules, such as a SIP User Agent (UA) 15, a SIP Server 17, a SIP Stack 23, and a data module such as the location server (LS) presence agent (PA) database (DB) 19.

The UA 15 may perform client services, such a registering the node with other nodes in the MANET and handling communications with other clients. The SIP Server 17 may provide registrar services and provide a presence agent, which may monitor the presence of nodes registered with the SIP server 17. All these generated packets may be routed to the correct destination by an Ad hoc On-demand Distance Vector protocol (AODV) Module referred to a MANET routing protocol 25 in FIG. 1.

Application program interface (API) layers 7-11 may provide access points for the MANET application 3 to communicate with the ESIP layer 1. For example, this can be accomplished with a Voice Session API 7, a Video-Session-API 9, a Test Session API 11, or a Multimedia Message API 13. The API layers 7-11 communicate with the UA 15. The UA 15 communicates with a Real Time Protocol (RTP)/Message Session Relay Protocol (MSRP) stack 21 and a SIP stack 23. Both the RTP/MSRP stack 21 and a SIP stack 23 may build upon the network routing protocol stack 5, for example, a TCP/IP stack. The network routing protocol stack 5 may be provided by an underlying operating system of the node.

The SIP server 17 may communicate with the LS/PA DB 19 and the SIP stack 23. The LS/PA DB 19 may store presence status information data regarding selected devices (referred to as buddies) on the MANET. The SIP stack 23 may store the ID-IP binding information and routing information for the MANET and is responsible for encoding/decoding the ESIP protocol messages.

The example embodiment may use unicast and broadcast techniques to communicate between nodes in the network.

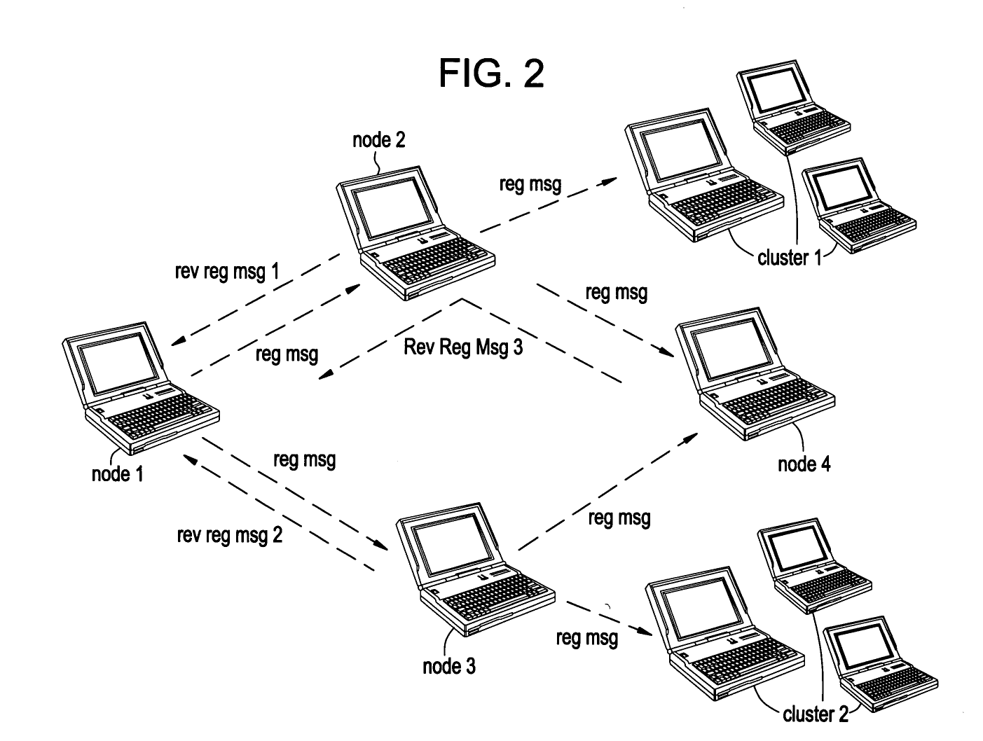

FIG. 2 illustrates a message flow in a network employing Broadcasting and hop-limited Batch Reverse Registration (BBRR), in accordance with an example embodiment of the present invention.

In FIG. 2, node₂ is a 1-hop neighbor of nodes, node₄, and cluster₁; and node₃ is a 1-hop neighbor of node₁, node₄, and cluster₂. However, there may be several ad hoc nodes between any pair of 1-hop neighbors, which do not support SIP, but support the underlying network routing protocol. The MANET routing protocol may support forward broadcasting packets, such that the protocol forwards the same broadcast packets only once, which is also known as flooding.

Node₁ may broadcast a registration message (reg msg) to all 1-hop neighbors, node₂ and node₃. Node₂ receives the registration message and evaluates whether to forward the registration message to its 1-hop neighbors. If node₂ decides to forward the registration message, it may modify the registration message (as will be described below) and broadcast the registration message to all its 1-hop neighbors, from whom node₂ has not received the registration message. Similarly, node₃ may receive, evaluate, modify, and broadcast the registration message to all its 1-hop neighbors. Notice that each node only forwards the registration message once and only to nodes that have not broadcast/forwarded the registration message. Upon receipt of the registration message, the receiving node or cluster may respond with a reverse registration message (e.g., rev reg msg₁, rev reg msg₂, and rev reg msg₃), via a unicast transmission.

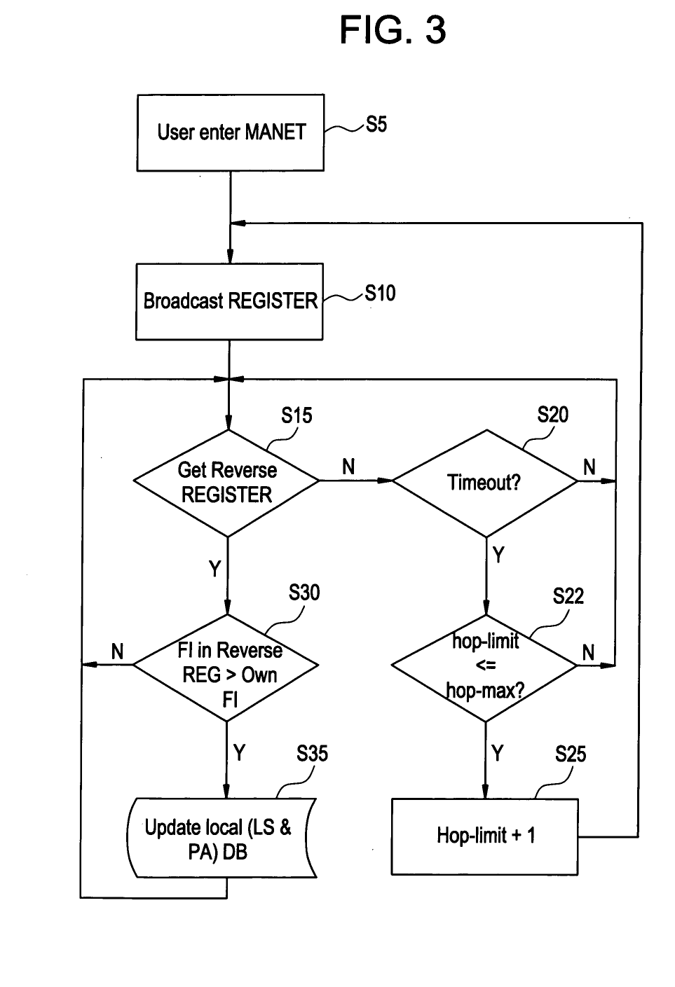

FIG. 3 illustrates a flow chart of an example embodiment of a method for requesting registration of a new node into a MANET, in accordance with the present invention.

As shown in FIG. 3, the registration process begins when a node enters the MANET, in step S5, and broadcasts a registration message to all its 1-hop neighbors, in step S110. For the purposes of example only, this embodiment will be described for the case where node₁ is the node entering the MANET. The registration message is a standard SIP registration message With ESIP extensions. The message may also include binding information associating the unique identifier (ID) of node₁ with the IP address of node₁, a presence status for node₁, a hop-limit for reverse registration to node₁, and a freshness indicator (FI).

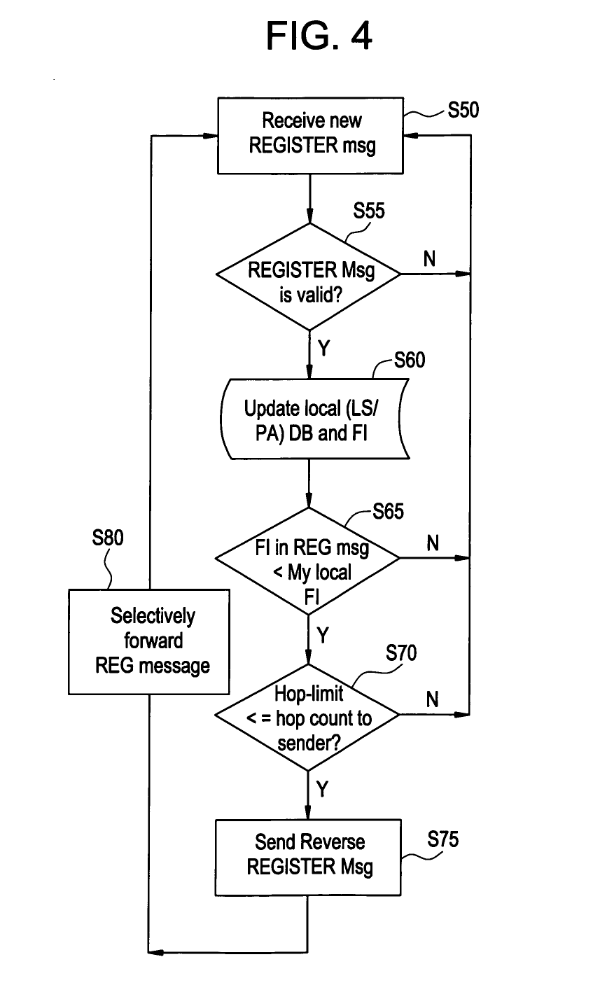

As will become clearer from the description of FIGS. 3 and 4 below, the freshness indicator (FI) may indicate the number of registration related messages processed directly or indirectly by a node. Stated another way, the freshness indicator may indicate the experience level of the node in the network or how new to the network the node is. For example, a FI of 1 may indicate that a node is a newcomer to the MANET. For any given node (nodeₓ), the FI of nodeₓ (FI) may be increased by 1 each time nodeₓ receives a registration message or cancel registration message. Each node may maintain the FI values of other nodes in their respective LS/PA DB. Furthermore, as will be shown below, the FI may be used to decrease the number of registration related messages in the MANET.

The registration process may fail under certain conditions due to the fading channel collision in the wireless network. Therefore, the example embodiment may also use on-demand, user initiated or periodic re-registration to refresh the registrar information in the node of the MANET. Alternatively, the example embodiment may use a user initiated query.

In step S15, node₁ waits to receive a reverse registration message. The reverse registration message from a nodeₓ may contain all binding information in the SIP stack of node. The SIP stack in nodeₓ may include a database, text file, or location in a volatile or non-volatile memory, which can be used to record, store, and retrieve the binding information. The binding information may associate one or more unique node identifiers in the MANET with one or more IP addresses, respectively. The reverse registration message may also include the freshness indicator FIₓ of nodeₓ, and a presence status of nodeₓ, if nodeᵢ is a buddy of nodeₓ.

In steps S20 and S22, if no reverse registration message is received from any other node within a timeout period and the current hop-limit for the registration message is less than a predetermined hop-limit, then, in step S25, node₁ may increase the hop-limit in the registration message and return to step S10. If in step S20 the time period has not expired or in step S22 the current hop-limit is equal to a maximum hop-limit, then node₁ returns to step S15.

If a reverse registration message is received from a nodeₓ in step S15, then the freshness indictor FIₓ of nodeₓ in the reverse registration message is compared with the freshness indictor FI₁ of node₁, in step S30. If the freshness indictor FIₓ of nodeₓ in the reverse registration message is not greater than the freshness indictor FI₁ of node₁, then the process returns to step S15. If the freshness indictor FIₓ of nodeₓ in the reverse registration message is greater than the freshness indictor FI₁ of node₁, then in step S35, node₁ may: (1) update the freshness indictor FI₁ of node₁ with the freshness indictor FIₓ of nodeₓ in the reverse registration message, for example, by setting FI₁ equal to FIₓ; (2) update the presence status of nodeₓ in the LS/PA DB of node₁, if nodeₓ is a buddy; and (3) update the binding information in the SIP stack 23 of node₁, for any nodes having binding information stored in the reverse registration message. Thereafter, processing may return to step S15 to await receipt of another reverse registration message.

Generally, the node having the largest freshness indicator FI value may contain the most complete SIP stack in the MANET because that node will have processed the largest number of registration and cancellation messages. Since node₁ may set its freshness indicator FI₁ equal to the freshness indicator FI included in the processed reverse registration message and may not process reverse registration message having a freshness indicator FI that is not greater than FI₁, the example embodiment reduces the likelihood that node₁ will perform unnecessary or redundant SIP stack updates.

FIG. 4 illustrates a flow chart of an example embodiment of a method for responding to a registration message in accordance with the present invention.

For the purposes of example only, the embodiment of FIG. 4 will be described for the case where a nodeₓ receives a registration message from node₁. In step S50 nodeₓ may receive a registration message from node₁. Next, in step S55, nodeₓ may verify whether the registration message is a valid. A valid registration message may conform to the ESIP protocol, and contain at least a freshness indicator FI and a hop-limit. If the registration message from node₁ is not valid, then the example embodiment may return to step S50 to receive another registration message. If the registration message is valid, then, in step S60, nodeₓ may update its LS/PA DB and SIP stack based on the information in the registration message. For example, the updates may include adding binding information of node₁ and presence status of node₁ to the LS/PA DB, and increasing the freshness indicator FIₓ for nodeₓ by 1.

Next, in steps S65 and S70, nodeₓ may determine whether to send a reverse registration message to node₁.

In step S65, nodeₓ may determine whether the freshness indicator FI₁ of node₁ is less than it own freshness indicator FIₓ. If not, then processing returns to step S50 where nodeₓ waits for the next registration message. If the freshness indicator FI₁ of node₁ is less than the freshness indicator FIₓ of nodeₓ then, processing proceed to step S70.

In step S70, nodeₓ may determine whether the hop-limit in the registration message is greater than or equal to a hop-count from nodeₓ to node₁. If the hop-limit in the registration message is not less than the hop-count from nodeₓ to nodeᵢ, then nodeₓ returns to step S50. However, if the hop-limit in the registration message is less than or equal to the hop count from nodeₓ to node₁, then processing proceeds to step S75. In step S75, nodeₓ may send a reverse registration message to nodeₓ the node from which the registration message originated. The process of deciding whether to respond and forward a registration message will be called hop-limited Batch Reversed Registration. The reverse registration message may contain all known binding information in the SIP stack of nodeₓ. The reverse registration message may also include the freshness indicator FIX and the presence status of nodeₓ, if node₁ is a buddy of nodeₓ.

Then, in step S80, nodeₓ may determine whether to forward the registration message to all its 1-hop neighbors. Regardless of whether or not nodeₓ may send a reverse registration message to node₁, if the hop-limit in the registration message from node₁ is greater than a hop-count from nodeₓ to node₁, then, nodeₓ may broadcast the registration message to all its 1-hop neighbors, except those neighbors from whom it received the registration message or any similar registration messages to register the same node. If nodeₓ decides to forward the registration, then nodeₓ may set the freshness indicator FI in the registration message equal to its freshness indicator FIₓ, if the FI in the registration message received in step S50 is smaller than FIₓ. Accordingly, the freshness indicator may also be thought of as indicating the freshness of the registration message.

In an alternate embodiment, nodeₓ may reduce the hop-limit in a registration message whenever it forwards the registration message. Thereafter, in order to establish whether a hop-count from nodeₓ to node₁ is greater than the hop-limit, each nodeₓ will only need to determine whether the hop-limit in the registration message is greater than zero in steps S70 and S80.

By limiting the forward transmission of the registration message from node₁ based on the freshness indicator and the hop-limit, it is possible to reduce the number of broadcast registration messages within the MANET. Furthermore, by replacing the freshness indicator FI in the registration message with a receiving node's higher freshness indicator value, if this value is greater than the freshness indicator in the received registration message, the example embodiment may increase the likelihood that only nodes with the most updated information will produce reverse registration messages.

If a node, such as node₁ in the examples above, decides to leave the MANET, that node may send a cancel registration message to its 1-hop neighbors. The cancel registration message indicates that the node, identified by its unique identifier, is leaving the MANET. Upon receiving the cancel registration message, a receiving node (nodeₓ) may (1) increase its freshness indicator by one; (2) set the ID-IP binding of the node sending the cancel registration message as un-usable; (3) update the presence status of the canceling node if the canceling node is a buddy of nodeₓ; and (4) broadcast the cancel registration message to 1-hop neighbors, however, it will never broadcast the same message twice.

The example embodiment provides various benefits. For example, multi-hop reverse registration allows any node to enter or leave the MANET with a single registration message exchange. Second, the example embodiments offer the benefit of batch registration, such that when nodes respond to a registration message from a registering node, each responding node will send all known binds to the registering node. Third, the example embodiments provide for controlled message broadcasting by providing a hop-limit to control the range of the message broadcasted. Fourth, the example embodiments provide presence status information in the registration messages, such that when a node responds to a registration message, the node also includes his presence status information to make himself update quicker. The example embodiments also provide for on-demand registration binding and relative distance detection measured in hop counts.

More generally, the example embodiments provide a standard compliant solution based on SIP, which makes it easy to interconnect with existing SIP-based communication networks. Since the MANET routing protocols employ the existing network routing protocols, not all nodes in the MANET are required to start a special SIP application in order to make the example embodiments function. Second, the example embodiments use fewer message exchanges and reduce channel collisions. The example embodiments provide fast presence status updates and allow a user to know the relative distance of his buddies.

The embodiments of the present invention provide for a Mobile Ad hoc Network (MANET) capable of providing network devices a method to communicate in areas where no base stations, routers, or access points are available, by providing a standards complaint solution with fewer message exchanges, fast presence updates and relative distance gauging.

The invention being thus described, it will be obvious that the same may be varied in many ways. For example, while described form a MANET based on the SIP standard, it will be appreciated that all or a portion of the embodiments may be implemented using alternate wireless or wire-based protocols and implementations, thus the present invention may be applicable to other types of networks. Such variations are not to be regarded as a departure from the invention, and all such modifications are intended to be included within the scope of the invention.

We claim:

1. A method for registering a first device in a mobile ad-hoc network (MANET), comprising:
sending a registration message to 1-hop neighboring devices, the registration message including a hop-limit and a freshness indicator of the first device, the freshness indicator indicating an experience level of the first device in the MANET and the hop-limit indicating a limit on the number of hops for forwarding the registration message.

2. The method of claim 1, further comprising:
incrementing the hop-limit if a reverse registration message is not received within a time-limit after sending the registration message and the hop-limit is less than a maximum hop-limit; and
sending a new registration message to the 1-hop neighboring devices, the new registration message including the incremented hop-limit and the freshness indicator.

3. The method of claim 1, wherein the sending step is performed by broadcasting the registration message, such that each of the 1-hop neighboring devices only forwards the registration message from the first device once.

4. The method of claim 1, wherein the registration message further includes at least one of binding information and presence status, the binding information indicating an association between a unique identifier of the first device and an IP address of the first device, and the presence status indicating the presence of the first device.

5. The method of claim 4, wherein the unique identifier is at least one of a medium access control (MAC) address, a social security number of a subscriber associated with the first device, a computer processing unit identifier, or a unique certificate.

6. The method of claim 1, further comprising:
receiving at least one reverse registration message from a second device; and
selectively updating a local database at the first device in response to information in the reverse registration message.

7. The method of claim 6, wherein the reverse registration message includes at least one of a freshness indicator for the second device, a presence status of the second device, and binding information from the second device.

8. The method of claim 7, wherein the selectively updating step updates the local database at the first device in response to information in the reverse registration message if the freshness indicator for the second device is greater than the freshness indictor for the first device.

9. The method of claim 8, wherein the updating step includes setting the freshness indicator for the first device equal to the freshness indicator for the second device.

10. The method of claim 7, wherein
the binding information includes binding information of the second device and binding information for other devices stored at the second device; and
the selectively updating step updates the local database with the binding information.

11. A method for registering a first device in a mobile ad-hoc network (MANET) at a second device, comprising:
receiving a registration message of the first device, the registration message including a first freshness indicator, the first freshness indicator indicating the freshness of the registration message; and
selectively sending a reverse registration message to the first device if the first freshness indicator is less than a second freshness indicator, the second freshness indicator indicating an experience level of the second device in the MANET.

12. The method of claim 11, wherein the registration message further includes at least one of binding information of the first device and a presence status of the first device, the binding information associating a unique identifier of the first device with an IP address of the first device and the presence status indicating the presence of the first device.

13. The method of claim 12, further comprising:
storing the binding information of the first device at the second device.

14. The method of claim 12, wherein the unique identifier is at least one of a medium access control (MAC) address, a social security number of a subscriber associated with the first device, a computer processing unit identifier, or a unique certificate.

15. The method of claim 11, wherein the reverse registration message includes at least one of a presence status information for the second device and binding information from the second device.

16. The method of claim 15, wherein the binding information includes binding information of the second device and binding information for other devices stored at the second device.

17. The method of claim 11, wherein
the registration message includes a hop-limit; and
the selectively sending step sends the reverse registration message to the first device if the first freshness indicator is less than a second freshness indicator and the number of hops between the second device and the first device is less than or equal to the hop-limit.

18. The method of claim 17, further comprising:
forwarding the registration message to 1-hop neighbors of the second device that did not send the registration message to the second device if the number of hops between the second device and the first device is less than or equal to the hop-limit, the forwarded registration message being altered to include the hop-limit minus a decrement amount.

19. The method of claim 11, wherein
the registration message includes a hop-limit; and
the selectively sending step sends the reverse registration message to the first device if the first freshness indicator is less than a second freshness indicator and the hop-limit is greater than zero.

20. The method of claim 19, further comprising:
forwarding the registration message to 1-hop neighbors of the second device that did not send the registration message to the second device if the hop-limit is greater than zero, the forwarded registration message being altered to include the hop-limit minus a decrement amount.

21. The method of claim 11, wherein the sending step send the reverse registration message such that the reverse registration message includes the second freshness indicator.
